(19) United States
(12) Patent Application Publication
(10) Pub. No.: US 2006/0281655 A1
(43) Pub. Date: Dec. 14, 2006

(54) Bleaching detergent or cleaning agent

(76) Inventors: Regina Stehr, Neuss (DE); Karl-Heinz Maurer, Erkrath (DE); Beatrix Kottwitz, Erkrath (DE); Inken Pruser, Dusseldorf (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/451,840

(22) Filed: Jun. 13, 2006

Related U.S. Application Data
(63) Continuation of application No. PCT/EP04/13143, filed on Nov. 19, 2004.

(30) Foreign Application Priority Data
Dec. 16, 2003 (DE) 103 58 827.2

(51) Int. Cl. C11D 3/00

(52) U.S. Cl. 510/375

(57) ABSTRACT

A detergent or cleaning agent that exhibits high bleaching properties without attacking the textiles to be cleaned or hard surfaces in an unreasonably harsh manner. Said aim is achieved by using a combination consisting of a percarbonate-based bleaching agent and a persulfate-based bleaching agent.

### CROSS-REFERENCE TO RELATED APPLICATIONS

This application is a continuation under 35 U.S.C. §365(c) and 35 U.S.C. §120 of International Application No. PCT/EP2004/013143, filed Nov. 19, 2004. This application also claims priority under 35 U.S.C. § 119 of German Patent Application No. 103 58 827.2, filed Dec. 16, 2003. The International Application and the German Application are incorporated herein by reference in their entireties.

### STATEMENT REGARDING FEDERALLY SPONSORED RESEARCH OR DEVELOPMENT

Not Applicable

### INCORPORATION BY REFERENCE OF MATERIAL SUBMITTED ON A COMPACT DISC

Not Applicable

### BACKGROUND OF THE INVENTION

(1) Field of the Invention

The invention relates to a bleaching washing or cleaning agent that contains two active bleaching agent substances of different kinds.

In order to enhance their performance, washing and cleaning agents have for some time contained so-called bleaching agents that, by way of redox reactions, attack stains present on the surface to be cleaned, and destroy stains that have already been detached from the surface in such a way that they cannot become redeposited onto the surface so as to be detected. In addition to the reductive bleaching agents, which play a subordinate role, oxidizing agents are used in particular, in this context. Although chlorine (accessible, for example, from hypochlorite) is a well-suited bleaching agent in principle because of its high oxidation potential, the oxidizing agents used are usually ones that utilize the oxidizing power of oxygen, since these agents present less risk of damage to the surface being cleaned.

(2) Description of Related Art, Including Information Disclosed Under 37 C.F.R. §§1.97 and 1.98.

Peroxygen compounds that have been described as being suitable for use in bleaching agents both in washing agents for cleaning textiles and in cleaning agents for hard surfaces are both inorganic and, in particular, organic peracids or peracid salts of organic acids such as, for example, phthalimidopercapronic acid, perbenzoic acid, or salts of diperdodecanedioic acid, but also hydrogen peroxide and inorganic salts that release hydrogen peroxide under washing or cleaning conditions, such as perborate, percarbonate, and/or persilicate. It has been repeatedly proposed, for example, in International Patent Applications WO 00/3604 and WO 00/3605, to utilize atmospheric oxygen as a bleaching agent, with the aid of substances that activate it such as aldehydes and transition-metal salts. It is also known that hydrogen peroxide can be generated in the context of washing or cleaning methods with the aid of an enzymatic system, i.e. an oxidase and its substrate. Efforts are nevertheless continually being made to find even more-effective bleaching agents and to optimize known bleaching agents so as to yield the highest possible bleaching performance without too unreasonably harsh an attack on the textile or hard surface to be cleaned.

### BRIEF SUMMARY OF THE INVENTION

Surprisingly, it has now been found that the bleaching result of washing agents and cleaning agents is reinforced, beyond that of such agents that contain only one of the two active substances, when both a percarbonate-based bleaching agent and a persulfate-based cleaning agent is used.

A subject of the invention is therefore a washing or cleaning agent containing percarbonate-based bleaching agent and persulfate-based bleaching agent.

The content of the combination of percarbonate-based bleaching agent and persulfate-based cleaning agent in the agents according to the present invention is by preference 10 wt % to 70 wt %, in particular, 15 wt % to 30 wt %, particularly preferably 20 wt % to 40 wt %. In an embodiment of the invention, the agent contains at least 5 wt %, by preference 7.5 wt % to 50 wt %, and in particular, 9 wt % to 35 wt %, persulfate-based bleaching agent.

In addition to the combination of percarbonate-based bleaching agent and persulfate-based bleaching agent, washing or cleaning agents according to the present invention can comprise all ingredients usually present therein, provided they do not interact in unreasonably negative fashion with the bleaching agents or with one of the bleaching agents. In a preferred embodiment, the agents according to the present invention are solid, in which context they can be present in powdered form or as larger shaped elements, for example, as granulated materials, extrudates, or tablets.

### BRIEF DESCRIPTION OF THE SEVERAL VIEWS OF THE DRAWING(S)

Not Applicable

### DETAILED DESCRIPTION OF THE INVENTION

The percarbonate-based bleaching agent contained in the agents according to the present invention is an addition product of hydrogen peroxide with an alkali carbonate, a so-called alkali percarbonate. Sodium percarbonate (theoretical composition: 2Na₂CO₃3.H₂O₂) is particularly preferred in this context. It can be produced using known methods, and if desired can be prepared in granular form or stabilized and, if applicable, encased, as is known, e.g., from International Patent Applications WO 91/15423, WO 92/17400, WO 92/17404, WO 93/04159, WO 93/04982, WO 93/20007, WO 94/03553, WO 94/05594, WO 94/14701, WO 94/14702, WO 94/24044, WO 95/02555, WO 95/02672, WO 95/06615, WO 95/15291, WO 95/15292, WO 95/18064, WO 95/18065, WO 95/23208, WO 95/23210, WO 96/11252, WO 96/11253, WO 96/14389, WO 96/19408, WO 96/23354, WO 97/19890, WO 97/35951, or WO 97/45524, or from European Patent Applications EP 0 745 664, EP 0 748 764, EP 0 791 642, EP 0 796 817, EP 0 873 971, EP 0 922 575, EP 0 962 424, EP 0 970 917, EP 1 127 840, or EP 1 149 800. In a preferred embodiment, it is possible to use an alkali percarbonate stabilized with special borates, as known from European Patent Applications EP 459 625, EP 487 256, or EP 567 140, or an alkali percarbonate encased with a combination of alkali salts, as known from European Patent Applications EP 0 623 553 or EP 0 592 969. As is evident from the theoretical formula indicated above, approximately 104.675 g sodium percarbonate can release approximately 1 mol active oxygen; the actual active-oxygen content of commercial sodium percarbonates can, however, also be less than this theoretical maximum value. This must be no means, or not exclusively, be attributed to a decomposition of the percarbonate, but instead can result from the presence in the commercial products of granulation or packaging adjuvants, or encasing materials.

The persulfate-based bleaching agents contained in the agents according to the present invention are preferably peroxomono- and -disulfuric acid and mixtures thereof, which can also be present in the form of their alkali salts and/or their acid alkali salts, i.e. as alkali hydrogenperoxomono- and -disulfates. Peroxomonosulfuric acid and/or its alkali salts or acid alkali salts are particularly preferred, among them in particular, potassium hydrogenperoxomonosulfate. They can be used as pure substances or, as applicable, in commercially usual form mixed with one another and/or mixed with the corresponding alkali sulfates or alkali hydrogensulfates. Particularly preferred is the use of potassium hydrogenperoxomonosulfate in the form of the triple salt of potassium hydrogenperoxomonosulfate, potassium hydrogensulfate, and potassium sulfate, such as that available commercially under the designations Curox®, Oxone®, or Caroat® and corresponding approximately to the empirical formula 2KHSO₅.KHSO₄.K₂SO₄. Its active oxygen content can thus be equal to approximately 1 mol per 307.365 g. Agents that contain such persulfate bleaching agents are known, for example, from European Patent Applications EP 0 135 226, EP 0 271 189, and EP 0 726 309 and from U.S. Pat. Nos. 3,556,711 and 5,559,089.

Further subjects of the invention are the use of a combination of a percarbonate-based bleaching agent with a persulfate-based bleaching agent to enhance the cleaning performance of washing or cleaning agents, as well as a method for washing laundry and a method for cleaning hard surfaces, in each case using a combination of a percarbonate-based bleaching agent with a persulfate-based bleaching agent. A washing or cleaning agent according to the present invention is preferably used in the context of the method according to the present invention, but the washing method according to the present invention can also be carried out in such a way that the percarbonate-based bleaching agent and the persulfate-based bleaching agent, premixed or as individual components, are metered into a washing machine or into a vessel provided for hand laundering; and that previously, simultaneously, or thereafter, a usual washing agent, which can be free of bleaching-agent components, is introduced into the washing machine or the hand laundering vessel. The same applies analogously to the method according to the present invention for cleaning hard surfaces. If it is desired to use the percarbonate-based bleaching agent and the persulfate-based bleaching agent in premixed form, it is also possible to utilize them in the form of an aqueous solution that contains both bleaching agents. It is likewise possible to dissolve them separately in water and to introduce the two resulting solutions separately into the washing or cleaning method. The same applies analogously to the use according to the present invention.

An agent according to the present invention contains the two bleaching agents, namely the percarbonate-based bleaching agent and the persulfate-based bleaching agent, preferably at a ratio between the molar active-oxygen quantities in the two (active oxygen ratio) of 10:1 to 1:10, in particular, of 4:1 to 1:4. Ratios in the range from 3:1 to 1:3, in particular, from 2.5:1 to 1:2.5, are particularly preferred, those of approximately 1:1, for example, 2:1 to 1:2, being very particularly preferred.

Washing or cleaning agents according to the present invention can contain, in addition to the aforesaid bleaching-agent combination, all other usual constituents of such agents that do not interact undesirably with the bleaching agents. In the context of the use according to the present invention and of the method according to the present invention, this interaction plays no part if agents of corresponding composition having constituents that otherwise interact undesirably are not allowed to come into contact with the bleaching-agent combination until shortly before the time of utilization, so that in such cases the agents used in addition to the bleaching-agent combination are subject to no particular restrictions with regard to their ingredients.

An agent according to the present invention can comprise bleach activators if desired, in particular, in quantities in the range from 2 wt % to 10 wt %. The group of suitable bleach activators encompasses the O- and/or N-acyl compounds usually used, for example, multiply acylated alkylenediamines, in particular, tetraacetylethylendiamine, acylated glycolurils, in particular, tetraacetyl glycoluril, N-acylated hydantoins, hydrazides, triazoles, urazoles, diketopiperazines, sulfurylamides, and cyanurates, also carboxylic acid anhydrides, in particular, phthalic acid anhydride, carboxylic acid esters, in particular, sodium isononanoyl phenolsulfonate, and acylated sugar derivatives, in particular, pentaacetylglucose, as well as cationic nitrile derivatives such as trialkylammoniumacetonitrile salts. To prevent interaction with the per-compounds during storage, the bleach activators can, in known fashion, have been coated or granulated with enveloping substances: tetraacetylethylenediamine granulated with the aid of carboxymethyl cellulose and having average particle sizes of 0.01 mm to 0.8 mm, as can be produced, for example, according to the method described in European Patent EP 37 026; granulated 1,5-diacetyl-2,4-dioxohexahydro-1,3,5-triazine, as can be produced according to the method described in German Patent DD 255 884; and/or trialkylammoniumacetonitrile prepared in particle form according to the methods described in International Patent Applications WO 00/50553, WO 00/50556, WO 02/12425, WO 02/12426, or WO 02/26927, are particularly preferred. Such bleach activators, if present, are contained in washing or cleaning agents preferably in quantities of up to 8 wt %, in particular, of 2 wt % to 6 wt %, in each case based on the entire agent. It is particularly advantageous, however, that agents according to the present invention exhibit very good bleaching performance even without the presence of usual bleach activators that form peracid under perhydrolysis conditions, or of bleach catalysts, for example, redox-active metal complexes; so that in a preferred embodiment, they are free of bleach activators and bleach catalysts.

In a further preferred embodiment, an agent according to the present invention contains nonionic surfactant, selected from fatty alkylpolyglycosides, fatty alkylpolyalkoxylates, in particular, -ethoxylates and/or -propoxylates, fatty acid polyhydroxyamides and/or ethoxylation and/or propoxylation products of fatty alkylamines, vicinal diols, fatty acid alkyl esters, and/or fatty acid amides, and mixtures thereof, in particular, in a quantity in the range from 1 wt % to 20 wt %.

Included among the suitable nonionic surfactants are the alkoxylates, in particular, the ethoxylates and/or propoxylates, of saturated or mono- to polyunsaturated linear or branched-chain alcohols having 10 to 22 C atoms, preferably 12 to 18 C atoms. The alkoxylation number of the alcohols is generally between 1 and 20, preferably between 3 and 10. They can be produced, in known fashion, by reacting the corresponding alcohols with the corresponding alkylene oxides. The derivatives of the fatty alcohols are particularly suitable, although their branched-chain isomers, in particular, so-called oxo alcohols, can also be used to produce usable alkoxylates. The alkoxylates, in particular, ethoxylates, of primary alcohols, having linear, in particular, dodecyl, tetradecyl, hexadecyl, or octadecyl radicals, as well as mixtures thereof, are accordingly usable. Corresponding alkoxylation products of alkylamines, vicinal diols, and carboxylic acid amides, which correspond to the aforesaid alcohols in terms of the alkyl portion, can furthermore be utilized. The ethylene-oxide and/or propylene-oxide insertion products of fatty acid alkyl esters, such as those that can be produced according to the method indicated in International Patent Application WO 90/13533, as well as fatty acid polyhydroxyamides such as those that can be produced according to the methods of U.S. Pat. No. 1,985,424, U.S. Pat. No. 2,016,962, and U.S. Pat. No. 2,703,798 as well as International Patent Application WO 92/06984, are additional possibilities. So-called alkylpolyglycosides that are suitable for incorporation into the agents according to the present invention are compounds of the general formula (G)ₙ-OR², in which R¹² denotes an alkyl or alkenyl radical having 8 to 22 C atoms, G a glycose unit, and n a number between 1 and 10. Such compounds and their production are described, for example, in European Patent Applications EP 92 355, EP 301 298, EP 357 969, and EP 362 671, or in U.S. Pat. No. 3,547,828. The glycoside component (G)ₙ refers to oligomers or polymers of naturally occurring aldose or ketose monomers, which include in particular, glucose, mannose, fructose, galactose, talose, gulose, altrose, allose, idose, ribose, arabinose, xylose, and lyxose. The oligomers made up of glycosidically linked monomers of this kind are characterized not only by the type of sugars contained in them, but also by the quantity thereof, the so-called oligomerization number. The oligomerization number n, as a magnitude to be ascertained analytically, generally assumes fractional numerical values; its value is between 1 and 10, and in the glycosides preferably used it has a value less than 1.5, in particular, between 1.2 and 1.4. A preferred monomer module, because of its good availability, is glucose. The alkyl or alkenyl portion R¹² of the glycosides likewise preferably derives from easily accessible derivatives of renewable raw materials, in particular, from fatty alcohols, although their branched-chain isomers, in particular, so-called oxo alcohols, can also be used to produce usable glycosides. The primary alcohols having linear octyl, decyl, dodecyl, tetradecyl, hexadecyl, or octadecyl radicals, as well as mixtures thereof, are accordingly particularly usable. Particularly preferred alkylglycosides contain a coconut fatty alkyl radical, i.e. mixtures in which essentially R¹²=dodecyl and R¹²=tetradecyl. Agents having an alkylpolyglycoside content in the range from 0.1 wt % to 7 wt % are particularly preferred.

A further embodiment of such agents encompasses the presence of a synthetic anionic surfactant of the sulfate and/or sulfonate type, in particular, fatty alkyl sulfate, fatty alkyl ether sulfate, sulfofatty acid esters, and/or sulfofatty acid di-salts, in particular, in a quantity in the range from 0.01 wt % to 15 wt %, preferably 0.01 wt % to 5 wt %. The anionic surfactant is preferably from the alkyl or alkenyl sulfates, and/or the alkyl or alkenyl ether sulfates, in which the alkyl or alkenyl group possesses 8 to 22, in particular, 12 to 18 C atoms.

To be mentioned as synthetic anionic surfactants that are particularly suitable for use in agents according to the present invention are the alkyl and/or alkenyl sulfates, having 8 to 22 C atoms, that carry an alkali, ammonium, or alkyl- or hydroxyalkyl-substituted ammonium ion as a counter-cation. Derivatives of fatty alcohols having, in particular, 12 to 18 C atoms, and their branched-chain analogs, the so-called oxo alcohols, are preferred. The alkyl and alkenyl sulfates can be produced in known fashion by reacting the corresponding alcohol components with a usual sulfating reagent, in particular, sulfur trioxide or chlorosulfonic acid, followed by neutralization with alkali, ammonium, or alkyl- or hydroxyalkyl-substituted ammonium bases. Also among the usable surfactants of the sulfate type are the sulfated alkoxylation products of the aforesaid alcohols, so-called ether sulfates. Such ether sulfates preferably contain 2 to 30, in particular, 4 to 10 ethylene glycol groups per molecule. The suitable anionic surfactants of the sulfonate type include the α-sulfo esters obtainable by reaction of fatty acid esters with sulfur trioxide and subsequent neutralization, in particular, sulfonation products deriving from fatty acids having 8 to 22 C atoms, preferably 12 to 18 C atoms, and from linear alcohols having 1 to 6 C atoms, preferably 1 to 4 C atoms, as well as the sulfofatty acids proceeding therefrom by formal saponification.

Soaps are possible as further optional surfactant-type ingredients, saturated fatty acid soaps such as the salts of lauric acid, myristic acid, palmitic acid, or stearic acid, as well as soaps derived from natural fatty acid mixtures, for example, coconut, palm kernel, or tallow fatty acids, being suitable. Those soap mixtures that comprise 50 wt % to 100 wt % saturated C₁₂-C₁₈ fatty acid soaps and up to 50 wt % oleic acid soap are preferred. Soap is contained preferably in quantities of 0.5 wt % to 7 wt %, but can also be entirely absent. Liquid or gelled agents according to the present invention in particular, however, can also contain larger soap quantities of, as a rule, up to 20 wt %.

If desired, the agents can also contain betaines and/or cationic surfactants that, if present, are used preferably in quantities of 0.5 wt % to 7 wt %. Among these the so-called esterquats, i.e. quaternized esters of carboxylic acid and aminoalcohol, are particularly preferred. These are known substances that can be obtained using the relevant methods of preparative organic chemistry. Reference may be made in this context to International Patent Application WO 91/01295, according to which triethanolamine is partially esterified with fatty acids in the presence of hypophosphoric acid, air is passed through, and quaternization is then performed with dimethyl sulfate or ethylene oxide. Also known, from German Patent DE 43 08 794, is a method for producing solid esterquats in which the quaternization of triethanolamine esters is carried out in the presence of suitable dispersants, preferably fatty alcohols. Overviews of this topic by, for example, R. Puchta et al. in Tens. Surf. Det., 30, 186 (1993), M. Brock in Tens. Surf. Det. 30, 394 (1993), R. Lagerman et al. in J. Am. Oil Chem. Soc., 71, 97 (1994), and 1. Shapiro in Cosm. Toil. 109, 77 (1994), have appeared.

In a further embodiment, an agent according to the present invention can contain water-soluble and/or water-insoluble builders, selected in particular, from alkali aluminosilicate, crystalline alkali silicate having a modulus greater than 1, monomeric polycarboxylate, polymeric polycarboxylate, and mixtures thereof, in particular, in quantities up to 60 wt %.

Included among the water-soluble organic builder substances are, in particular, those from the class of the polycarboxylic acids, in particular, citric acid and sugar acids, as well as the polymeric (poly)carboxylic acids, in particular, the polycarboxylates, accessible by oxidation of polysaccharides, of International Patent Application WO 93/16110, polymeric acrylic acids, methacrylic acids, maleic acids, and mixed polymers thereof, which can also contain small polymerized-in proportions of polymerizable substances having no carboxylic acid functionality. The relative molecular weight of the homopolymers of unsaturated carboxylic acids is generally between 5,000 and 200,000, that of the copolymers between 2,000 and 200,000, preferably 50,000 to 120,000, based on free acid. A particularly preferred acrylic acid/maleic acid copolymer has a relative molecular weight of 50,000 to 100,000. Compounds of this class that are suitable although less preferred are copolymers of acrylic acid or methacrylic acid with vinyl ethers such as vinyl methyl ethers, vinyl esters, ethylene, propylene, and styrene, in which the proportion of acid is at least 50 wt %. Also usable as water-soluble organic builder substances are terpolymers that contain two carboxylic acids and/or their salts as monomers, and vinyl alcohol and/or a vinyl alcohol derivative or a carbohydrate as a third monomer. The first acid monomer or its salt is derived from a monoethylenically unsaturated C₃-C₈ carboxylic acid and preferably from a C₃-C₄ monocarboxylic acid, in particular, from (meth)acrylic acid. The second acid monomer or its salt can be derivative of a C₄-C₈ dicarboxylic acid, maleic acid being particularly preferred. The third monomer unit is in this case constituted by vinyl alcohol and/or preferably an esterified vinyl alcohol. Particularly preferred are vinyl alcohol derivatives that represent an ester of short-chain carboxylic acids, for example, of C₁-C₄ carboxylic acids, with vinyl alcohol. Preferred terpolymers contain 60 wt % to 95 wt %, in particular, 70 wt % to 90 wt %, (meth)acrylic acid or (meth)acrylate, particularly preferably acrylic acid or acrylate, and maleic acid or maleinate, as well as 5 wt % to 40 wt %, preferably 10 wt % to 30 wt %, vinyl alcohol and/or vinyl acetate. Very particularly preferred in this context are terpolymers in which the weight ratio of (meth)acrylic acid or (meth)acrylate to maleic acid or maleate is between 1:1 and 4:1, preferably between 2:1 and 3:1, and in particular, 2:1 and 2.5:1. Both the quantities and the weight ratios are based on the acids. The second acid monomer or its salt can also be a derivative of an allylsulfonic acid that is substituted in the 2-position with an alkyl radical, preferably with a C₁-C₄ alkyl radical, or with an aromatic radical that preferably derives from benzene or benzene derivatives. Preferred terpolymers contain 40 wt % to 60 wt %, in particular, 45 to 55 wt %, (meth)acrylic acid or (meth)acrylate, particularly preferably acrylic acid or acrylate, 10 wt % to 30 wt %, preferably 15 wt % to 25 wt %, methallylsulfonic acid or methallylsulfonate, and 15 wt % to 40 wt %, preferably 20 wt % to 40 wt %, of a carbohydrate as the third monomer. This carbohydrate can be, for example, a mono-, di-, oligo-, or polysaccharide, mono-, di-, or oligosaccharides being preferred; sucrose is particularly preferred. The use of the third monomer probably causes the incorporation into the polymer of defined break points, which are responsible for the polymer's good biodegradability. These terpolymers can be produced in particular, using methods that are described in German Patent DE 42 21 381 and German Patent Application DE 43 00 772, and generally have a relative molecular weight of between 1,000 and 200,000, preferably between 200 and 50,000, and in particular, between 3,000 and 10,000. Especially for the production of liquid agents, they can be used in the form of aqueous solutions, preferably in the form of 30-wt % to 50-wt % aqueous solutions. All the aforesaid polycarboxylic acids are used, as a rule, in the form of their water-soluble salts, in particular, their alkali salts. An agent according to the present invention preferably contains 0.1 wt % to 15 wt % water-soluble organic builders.

Crystalline or amorphous alkali aluminosilicates are used in particular, as water-insoluble, water-dispersible inorganic builder materials, in quantities of up to 50 wt %, preferably no more than 40 wt %, and in liquid agents in particular, of 1 wt % to 5 wt %. Among these, the crystalline aluminosilicates of washing-agent grade, in particular, zeolite NaA and optionally NaX, are preferred. Quantities close to the aforesaid upper limit are preferably used in solid, particulate agents. Suitable aluminosilicates exhibit, in particular, no particles having a particle size greater than 30 mm, and preferably comprise at least 80 wt % of particles having a size less than 10 mm. Their calcium binding capability, which can be determined as indicated in German Patent DE 24 12 837, is in the range from 100 to 200 mg CaO per gram. Suitable substitutes or partial substitutes for the aforesaid aluminosilicate are crystalline alkali silicates that can be present alone or mixed with amorphous silicates. The alkali silicates usable in the agents as detergency builders preferably exhibit a molar ratio of alkaline oxide to SiO₂ of less than 0.95, in particular, of 1:1.1 to 1:12, and can be present in amorphous or crystalline form. Preferred alkali silicates are the sodium silicates, in particular, the amorphous sodium silicates, having a molar Na₂O:SiO₂ ratio of 1:2 to 1:2.8. Amorphous alkali silicates of this kind are obtainable commercially, for example, under the name Portil®. Those having a molar Na₂O:SiO₂ ratio of 1:1.9 to 1:2.8 can be produced according to the method of European Patent Application EP 0 425 427. They are added in the context of production preferably as a solid and not in the form of a solution. Crystalline sheet silicates of the general formula NaSiₓO₂ₓ₊₁.H₂O, in which x (the so-called modulus) is a number from 1.9 to 4, and y is a number from 0 to 20, and preferred values for x are 2, 3, or 4, are preferably used as crystalline silicates that can be present alone or mixed with amorphous silicates. Crystalline sheet silicates that conform to this general formula are described, for example, in European Patent Application EP 0 164 514. Preferred crystalline sheet silicates are those in which x assumes a value of 2 or 3 in the aforesaid general formula. Both β- and δ-sodium disilicates (Na₂Si₂O₅.yH₂O) are particularly preferred; ,-sodium disilicate can be obtained, for example, according to the method described in International Patent Application WO 91/08171. δ-Sodium silicates having a modulus of between 1.9 and 3.2 can be produced in accordance with Japanese Patent Applications JP 04/238 809 or JP 04/260 610. Practically anhydrous crystalline alkali silicates, produced from amorphous alkali silicates and of the aforesaid general formula in which x denotes a number from 1.9 to 2.1, which can be produced as described in European Patent Applications EP 0 548 599, EP 0 502 325, and EP 0 425 428, can also be used in agents according to the present invention. In a further preferred embodiment of the agents, a crystalline sodium sheet silicate having a modulus of 2 to 3 is used, such as the one that can be produced from sand and soda using the method of European Patent Application EP 0 436 835. Crystalline sodium silicates having a modulus in the range from 1.9 to 3.5, such as those obtainable according to the methods of European Patent EP 0 164 552 and/or European Patent Application EP 0 294 753, are used in a further preferred embodiment of washing or cleaning agents according to the present invention. Their alkali silicate content is preferably 1 wt % to 50 wt %, and in particular, 5 wt % to 35 wt %, based on anhydrous active substance. If an alkali aluminosilicate, in particular, zeolite, is also present as an additional builder substance, the alkali silicate content is preferably 1 wt % to 15 wt %, and in particular, 2 wt % to 8 wt %, based on anhydrous active substance. The weight ratio of aluminosilicate to silicate, based in each case on anhydrous active substances, is then preferably 4:1 to 10:1. In agents that contain both amorphous and crystalline alkali silicates, the weight ratio of amorphous alkali silicate to crystalline alkali silicate is preferably 1:2 to 2:1, and in particular, 1:1 to 2:1.

The known alkali phosphates, in particular, trisodium polyphosphate, are also suitable as water-soluble inorganic builder substances. “Alkali phosphate” is the summary designation for the alkali-metal (in particular, sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance. Sodium dihydrogenphosphate, NaH₂PO₄, exists as the dihydrate (density 1.91 gcm⁻³, melting point 600) and as the monohydrate (density 2.04 gcm⁻³). Both salts are white powders that are very easily soluble in water and that lose their water of crystallization upon heating and transition at 200° C. into the weakly acid diphosphate (disodium hydrogendiphosphate, Na₂H₂P₂O₇), and at higher temperature into sodium trimetaphosphate (Na₃P₃O₉) and Maddrell salt. NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 2530 (decomposing to form (KPO₃)ₓ, potassium polyphosphate), and is easily soluble in water. Disodium hydrogenphosphate (secondary sodium phosphate), Na₂HPO₄, is a colorless, very easily water-soluble crystalline salt. It exists anhydrously and with 2 mol (density 2.066 gcm⁻³, water lost at 950), 7 mol (density 1.68 gcm⁻³, melting point 480 with loss of 5H₂O), and 12 mol of water (density 1.52 gcm⁻³, melting point 350 with loss of 5H₂O); it becomes anhydrous at 1000 and when more strongly heated transitions into the diphosphate Na₄P₂O₇. Disodium hydrogenphosphate is produced by the neutralization of phosphoric acid with a soda solution using phenolphthalein as indicator. Dipotassium hydrogenphosphate (secondary or dibasic potassium phosphate), K₂HPO₄, is an amorphous white salt that is easily soluble in water. Trisodium phosphate (tertiary sodium phosphate), Na₃PO₄, exists as colorless crystals that as the dodecahydrate have a density of 1.62 gcm⁻³ and a melting point of 73-76° C. (decomposition), as the decahydrate (corresponding to 19-20% P₂O₅) a melting point of 100° C., and in the anhydrous form (corresponding to 39-40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1,340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning agent industry. Tetrasodium diphosphate (sodium pyrophosphate), Na₄P₂O₇, exists in anhydrous form (density 2.534 gcm⁻³, melting point 988°, also indicated as 880°) and as the decahydrate (density 1.815-1.836 gcm⁻³, melting point 940 with loss of water). Both substances are colorless crystals that are soluble in water with an alkaline reaction. Na₄P₂O₇ is created when disodium phosphate is heated to >2000, or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 250. Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter in particular, a number of designations are in use: fused or thermal phosphates, Graham salt, Kurrol's salt, and Maddrell salt. All the higher sodium and potassium phosphates are together referred to as “condensed” phosphates. The technically important pentasodium triphosphate Na₅P₃O₁₀ (sodium tripolyphosphate) is a white, water-soluble, non-hygroscopic salt, crystallizing anhydrously or with 6H₂O, of the general formula NaO—[P(O)(ONa)-O]ₙ—Na, where n=3. Approximately 17 g of the salt containing no water of crystallization dissolves in 100 g of water at room temperature, approx. 20 g at 60° C., and approx. 32 g at 1000; after the solution is heated to 1000 for two hours, approx. 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.). Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing and cleaning agent industry. Sodium potassium tripolyphosphates also exist; these are likewise usable in the context of the present invention. They are produced, for example, when sodium trimetaphosphate is hydrolyzed with KOH:
(NaPO₃)₃+2 KOH→Na₃K₂P₃O₁₀+H₂O
These are usable in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate, can also be used.

In addition to the aforesaid builder substances, further water-soluble or water-insoluble inorganic substances can be used in agents according to the present invention. The alkali carbonates, alkali hydrogencarbonates, and alkali sulfates, as well as mixtures thereof, are suitable in this context. Additional inorganic material of this kind can be present in quantities of up to 70 wt %.

The agents can additionally contain further constituents that are usual in washing and cleaning agents. These optional constituents include, in particular, enzymes, enzyme stabilizers, complexing agents for heavy metals, for example, aminopolycarboxylic acids, aminohydroxypolycarboxylic acids, polyphosphonic acids and/or aminopolyphosphonic acids, color fixing ingredients, color transfer inhibitors, for example, polyvinylpyrrolidone or polyvinylpyridine-N-oxide, foam inhibitors, for example, organopolysiloxanes or paraffins, solvents, thickeners, and optical brighteners, for example, stilbenedisulfonic acid derivatives. Preferably up to 1 wt %, in particular, 0.01 wt % to 0.5 wt % optical brighteners, in particular, compounds of the class of the substituted 4,4′-bis-(2,4,6-triamino-s-triazinyl)stilbene-2,2′-disulfonic acids, up to 5 wt %, in particular, 0.1 wt % to 2 wt %, complexing agents for heavy metals, in particular, aminoalkylenephosphonic acids and their salts, up to 3 wt %, in particular, 0.5 wt % to 2 wt %, graying inhibitors, and up to 2 wt %, in particular, 0.1 wt % to 1 wt %, foam inhibitors, are contained in agents according to the present invention, the aforesaid weight proportions referring in each case to the entire agent.

Solvents that can be used, in particular, in liquid or gelled agents are, in addition to water, preferably those that are miscible with water. These include the lower alcohols, for example, ethanol, propanol, isopropanol, and the isomeric butanols, glycerol, lower glycols, for example, ethylene and propylene glycol, and the ethers derivable from the aforesaid classes of compounds. Liquid agents according to the present invention are preferably anhydrous.

Enzymes that may optionally be present are preferably selected from the group comprising protease, amylase, lipase, cellulase, hemicellulase, oxidase, peroxidase, or mixtures thereof. Protease, obtained from microorganisms such as bacteria or fungi, is especially suitable. It can be obtained in known fashion, by fermentation processes, from suitable microorganisms that are described, for example, in German Unexamined Applications DE 19 40 488, DE 20 44 161, DE 21 01 803, and DE 21 21 397, U.S. Pat. Nos. 3,623,957 and 4,264,738, European Patent Application EP 006 638, and International Patent Application WO 91/02792. Proteases are obtainable commercially, for example, under the names BLAP®, Savinase®, Esperase®, Maxatase®, Optimase®, Alcalase®, Durazym®, or Maxapem®. Lipase is usable and can be obtained from Humicola lanuginosa as described, e.g., in European Patent Applications EP 258 068, EP 305 216, and EP 341 947, from Bacillus species as described, for example, in International Patent Application WO 91/16422 or European Patent Application EP 384 717, from Pseudomonas species as described, for example, in European Patent Applications EP 468 102, EP 385 401, EP 375 102, EP 334 462, EP 331 376, EP 330 641, EP 214 761, EP 218 272, or EP 204 284 or International Patent Application WO 90/10695, from Fusarium species as described, for example, in European Patent Application EP 130 064, from Rhizopus species as described, for example, in European Patent Application EP 117 553, or from Aspergillus species as described, for example, in European Patent Application EP 167 309. Suitable lipases are obtainable commercially, for example, under the names Lipolase®, Lipozym®, Lipomax®, Amano®-Lipase, Toyo-Jozo®-Lipase, Meito®-Lipase, and Diosynth®-Lipase. Suitable amylases are on the market, for example, under the names Maxamyl®, Termamyl®, Duramyl®, and Purafect® OxAm. Cellulase is usable and can be an enzyme, obtainable from bacteria or fungi, that exhibits an optimum pH preferably in the weakly acid to weakly alkaline region from 6 to 9.5. Cellulases of this kind are known, for example, from German Unexamined Applications DE 31 17 250, DE 32 07 825, DE 32 07 847, DE 33 22 950, or European Patent Applications EP 265 832, EP 269 977, EP 270 974, EP 273 125, and EP 339 550, and from International Patent Applications WO 95/02675 and WO 97/14804, and are commercially available under the names Celluzyme®, Carezyme®, and Ecostone®.

The usual enzyme stabilizers that are optionally present, in particular, in liquid and/or gelled agents, include aminoalcohols, for example, mono-, di-, and triethanolamine and -propanolamine and mixtures thereof, lower carboxylic acids such as those known, for example, from European Patent Applications EP 376 705 and EP 378 261, boric acid or alkali borates, boric acid/carboxylic acid combinations as known, for example, from European Patent Application EP 451 921, boric acid esters as known, for example, from International Patent Application WO 93/11215 or European Patent Application EP 511 456, boronic acid derivatives as known, for example, from European Patent Application EP 583 536, calcium salts, for example, the Ca/formic acid combination known from European Patent EP 28 865, magnesium salts as known, for example, from European Patent Application EP 378 262, and/or sulfur-containing reducing agents as known, for example, from European Patent Applications EP 080 748 or EP 080 223.

The suitable foam inhibitors include long-chain soaps, in particular, behenic soap, fatty acid amides, paraffins, waxes, microcrystalline waxes, organopolysiloxanes, and mixtures thereof, which moreover can contain microfine, optionally silanated or otherwise hydrophobized silicic acid. For use in particulate agents, foam inhibitors of this kind are preferably bound to granular, water-soluble carrier substances as described, for example, in German Unexamined Application DE 34 36 194, European Patent Applications EP 262 588, EP 301 414, EP 309 931, or European Patent EP 150 386.

### EXAMPLES

### Example 1

Standardized stains (tea, red wine) on white cotton fabric were washed at 30° C. with a particulate washing agent V0 (4 g/L) containing no bleaching agent. In addition, a washing agent V1 that had been obtained from V0 by the addition of sodium percarbonate, and a washing agent V2 that had been obtained from V0 by the addition of TAED (6.25 wt % based on V0) and sodium percarbonate, were used. Sodium percarbonate was used in each case in a quantity such that at a 4 g/L concentration of the respective agent, a calculated 130 ppm of active oxygen was obtained from it in the washing solution. Alternatively, potassium monopersulfate (in a quantity such that a calculated 130 ppm is obtained for a 4 g/L concentration of the agent in the washing solution) was mixed into V0 (agent V3). In order to arrive at the agents M1 to M3 according to the present invention, mixtures (M1, 75:25; M2, 50:50; M3, 25:75) of the active oxygen sources sodium percarbonate and potassium monopersulfate were added to V0. The aforesaid bleaching agent combinations were also used in quantities such that when 4 g/l of each resulting agent was used, the active oxygen content in the washing solution was a calculated 130 ppm. The washed and rinsed cotton test fabrics were then dried, ironed, and examined (remission determination, Minolta CM 508d). A significant improvement in remission with the use of the agents according to the present invention was detected, although the active oxygen contents in the washing solution were the same. Table 1 below indicates the brightness differences L* with respect to the test fabric washed only with V0.

TABLE 1

| | Tea | Red wine |
|---|---|---|
| V1 | −0.01 | −0.2 |
| V2 | 1.6 | 1.6 |
| V3 | 0.6 | n.d. |
| M1 | 2.1 | n.d. |
| M2 | 2.4 | 1.2 |
| M3 | 0.8 | 2.4 |

n.d.: not determined

### Example 2

Example 1 was repeated, this time using agents to which the bleaching agents or bleaching agent combinations were added in quantities such that with the use of 4 g/l of the respective agent, the active oxygen content in the washing solution was a calculated 300 ppm. Table 2 below once again indicates the brightness differences L* with respect to the test fabric washed only with V0.

TABLE 2

| | Tea | Red wine |
|---|---|---|
| V1′ | 0.9 | 0.8 |
| V2′ | 2.8 | 2.0 |
| V3′ | 2.1 | 4.4 |
| M1′ | 4.3 | n.d |
| M2′ | 4.2 | 5.3 |
| M3′ | 2.9 | 4.9 |

n.d.: not determined

### Example 3

Example 1 was repeated, this time using agents to which the bleaching agents or bleaching agent combinations were added in quantities such that with the use of 4 g/l of the respective agent, the active oxygen content in the washing solution was a calculated 500 ppm. Table 3 below once again indicates the brightness differences L* with respect to the test fabric washed only with V0.

TABLE 3

| | Tea | Red wine |
|---|---|---|
| V1″ | 1.4 | 0.2 |
| V2″ | 2.9 | 1.8 |
| V3″ | 0.8 | 3.7 |
| M1″ | 8.7 | 6.2 |
| M2″ | 7.4 | 7.7 |
| M3″ | 6.5 | 6.3 |

1. A washing or cleaning composition comprising percarbonate-based bleaching agent and persulfate-based bleaching agent.

2. A composition according to claim 1, wherein the composition comprises percarbonate-based bleaching agent and persulfate-based bleaching agent at an active-oxygen ratio of 10:1 to 1:10.

3. The composition according to claim 2, wherein the active-oxygen ratio is 4:1 to 1:4.

4. The composition according to claim 1, wherein the percarbonate-based bleaching agent is an alkali percarbonate.

5. The composition according to claim 4, wherein the alkali percarbonate is sodium percarbonate.

6. The composition according to claim 1, wherein the persulfate-based bleaching agent comprises at least one of peroxomono- and -disulfuric acid, their alkali salts and/or their acid alkali salts.

7. The composition according to claim 6, wherein the persulfate-based bleaching agent is selected from the group consisting of potassium peroxodisulfate and potassium hydrogenperoxomonosulfate, and mixtures thereof.

8. The composition according to claim 1, wherein the persulfate-based bleaching agent is selected from the group consisting of the triple salt of potassium, hydrogenperoxomonosulfate, potassium hydrogen sulfate, and potassium sulfate that corresponds approximately to the empirical formula 2KHSO₅.KHSO₄.K₂SO₄.

9. The composition according to claim 1, wherein the concentration of the combination of percarbonate-based bleaching agent and persulfate-based bleaching agent in the composition is 10 wt. % to 70 wt. %.

10. The composition according to claim 9, wherein the concentration of the combination of percarbonate-based bleaching agent and persulfate-based bleaching agent in the composition is 15 wt. % to 30 wt. %.

11. The composition according to claim 1, wherein the concentration of the percarbonate-based bleaching agent in the composition is 7.5 wt. % to 50 wt. %.

12. The composition according to claim 1, wherein the composition further comprises at least one bleach activator.

13. A washing or cleaning composition comprising sodium percarbonate and potassium monopersulfate.

14. The composition according to claim 13, wherein the sodium percarbonate and potassium monopersulfate are present in an active-oxygen ratio of 10:1 to 1:10.

15. The composition according to claim 13, wherein the concentration of sodium percarbonate and potassium monopersulfate in the composition is 10 wt. % to 70 wt. %.

16. The composition according to claim 13, wherein the concentration of the potassium monopersulfate in the composition is 7.5 wt. % to 50 wt. %.

17. A process for enhancing the cleaning performance of washing or cleaning compositions comprising the step of adding to the compositions a combination of a percarbonate-based bleaching agent with a persulfate-based bleaching agent.

18. The process of claim 17, wherein the percarbonate-based bleaching agent is sodium percarbonate and the persulfate-based bleaching agent is potassium monopersulfate.

19. The process for washing laundry comprising the step of contacting the laundry with the composition of claim 1.

20. The process for cleaning hard surfaces comprising the step of contacting the hard surfaces with the composition of claim 1.
